(19) United States
(12) Patent Application Publication
(10) Pub. No.: US 2006/0234619 A1
(43) Pub. Date: Oct. 19, 2006

(54) Intake duct for vehicle

(75) Inventors: Hiroyuki Mori, Aichi-ken (JP); Hiroshi Iwao, Aichi-ken (JP); Hitoshi Kino, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/386,720

(22) Filed: Mar. 23, 2006

(30) Foreign Application Priority Data
Mar. 25, 2005 (JP) JP 2005-089332

(51) Int. Cl. B60H 1/00

(52) U.S. Cl. 454/107

(57) ABSTRACT

A grommet provided with an annular engaging groove serving as an engaging means is fixed to a distal end portion of a column portion. A mating engaging means, which has a through hole serving as an escape opening and is detachable with the annular engaging groove by an opening peripheral edge portion defining this through hole, is formed in a lower duct wall portion at a position corresponding to the column portion. If an external load of a predetermined value or more is applied to an upper duct wall portion, and a state of engagement between the annular engaging groove and the opening peripheral edge portion is thereby canceled, the column portion enters the through hole without being fractured or damaged, and the upper duct wall portion is deformed toward the lower duct wall portion side.

This application is based on Japanese Patent Application No. 2005-089332, which is incorporated herein by reference.

### BACKGROUND OF THE INVENTION

1. Field of the Invention

The present invention relates to an intake duct for a vehicle, and more particularly to an intake duct for a vehicle having a column portion serving as a so-called reinforcing rib and provided to ensure rigidity necessary for resisting intake negative pressure and the like.

2. Description of the Related Art

An intake duct for a vehicle is for improving an engine output by improving the combustion efficiency of an engine by supplying outside air sucked in from the outside to the engine through an air cleaner. There are cases where such an intake duct for a vehicle is installed in a gap between a hood (a hood panel) and a radiator upper support in a front portion of a vehicle body in order to efficiently suck in the outside air during the traveling of the vehicle.

In such an intake duct for a vehicle, intake negative pressure (a phenomenon in which the internal pressure of the duct becomes lower than the atmospheric pressure owing to intake) acts such as when the outside air is sucked in during the starting of the engine. For this reason, if the intake duct does not have rigidity capable of withstanding this intake negative pressure, an upper wall portion of the duct and a lower wall portion of the duct become deformed in such a manner as to approach each other, which in some cases can possibly lead to the blockage of an intake port due to collapsing deformation. In that case, a necessary amount of outside air fails to be introduced into the engine, and such trouble as a decline in the engine output occurs.

On the other hand, in recent years, shock absorbing bodies have come to be developed in which consideration has been given to ensure that, by such as weakening the rigidity of the frame of the hood, when an obstacle or the like has erroneously collided against the hood, more than a necessary force will not be applied to the obstacle or the like by absorbing the shock as the hood is appropriately deformed. In such a shock absorbing body, it must be ensured that excessive deformation of the hood will not be suppressed by the intake duct which is disposed in an engine compartment immediately below the hood.

Accordingly, an intake duct for a vehicle is known which is capable of allowing the excessive deformation of the hood at an abnormal time of a shock while attempting to improve the rigidity to resist the intake negative pressure and the like at normal times (e.g., refer to JP-A-2004-124757 (FIGS. 1, 2, 6, and 8) and JP-A-2004-183514 (FIGS. 1, 3, 5, and 7)).

The intake duct for a vehicle disclosed in JP-A-2004-124757 is molded from a resin material. As shown in FIG. 7, this intake duct for a vehicle includes an upper duct wall portion 81 disposed in close proximity to the reverse side of the hood of the vehicle; a lower duct wall portion 83 which is disposed to the upper duct wall portion 81 with a required space provided therebetween and which forms, together with the upper duct wall portion 81, an intake port which is open toward the front side of the vehicle and an intake passage 82 for supplying the outside air sucked from the intake port to the engine side; and a supporting wall portion 85 which protrudes integrally from the lower duct wall portion 83 and whose flat-shaped support portion 84, i.e., its protruded distal end surface, is joined to the reverse surface of the upper duct wall portion 81 by fusion to serve as a supporting portion for supporting the upper duct wall portion 81. Planned fracture lines 86 surrounding the supporting wall portion 85 are provided in connecting regions between the supporting wall portion 85 and the lower duct wall portion 83. These planned fracture lines 86 are constituted by a plurality of thin-walled portions 87 provided in straight rows at required intervals in the connecting regions (or by a thin-walled portion extending linearly over the entire periphery in the connecting region) In this intake duct for a vehicle, when the hood is deformed downwardly by a collision with an obstacle or the like, and the upper duct wall portion 81 is pressed from above with an impact force, the supporting wall portion 85 which received this pressing force from the upper duct wall portion 81 by the flat-shaped support portion 84 is pressed downwardly without being accompanied by its own buckling deformation. Then, since a stress due to this pressing force acts on the thin-walled portions 87 which form the planned fracture lines 86, a fracture occurs along the planed fracture lines 86, and the supporting wall portion 85 is separated from the lower duct wall portion 83 and moves downwardly. As a result, further deformation of the hood is allowed, accompanying the caving in of the upper duct wall portion 81.

In addition, the intake duct for a vehicle disclosed in JP-A-2004-183514 is similarly formed from a resin material, and has the same basic construction as the intake duct for a vehicle disclosed in JP-A-2004-124757. As shown in FIG. 8, this intake duct for a vehicle includes the upper duct wall portion 81; the lower duct wall portion 83; and the supporting wall portion 85 having the flat-shaped support portion 84. Opposing both side wall portions of the supporting wall portion 85 are bent at their intermediate portions. Each of the both side wall portions consists of a first supporting portion 88 located on the upper duct wall portion 81 side and extending at a first inclined angle α with respect to a vertical direction, as well as a second supporting portion 89 located on the lower duct wall portion 83 side by being bent from and connected to the first supporting portion 88 and extending at a second inclined angle β which is greater than the first inclined angle α. Namely, the both side wall portions of the supporting wall portion 85 are formed in a shape in which they flare out from the distal end side toward the proximal end side, and the degree of flare of the second supporting portion 89 is made greater than the degree of flare of the first supporting portion 88.

In this intake duct for a vehicle, in the same way as the intake duct for a vehicle disclosed in JP-A-2004-124757, when the hood is deformed downwardly by a collision with an obstacle or the like, and the upper duct wall portion 81 is pressed from above with an impact force, the flat-shaped support portion 84 of the supporting wall portion 85 receives the pressing force from the upper duct wall portion 81 by the surface. The supporting wall portion 85 which received this pressing force by the flat-shaped support portion 84 is further bent such that the bent portions of the both side wall portions approach each other, and the first supporting portions 88 are deformed in a curved manner so as to expand to the outside. Hence, the supporting wall portion 85 is deformed into a collapsed state in which it is crushed in its entirety. As a result, further deformation of the hood is allowed, accompanying the caving in of the upper duct wall portion 81.

However, with the related intake duct for a vehicle disclosed in JP-A-2004-124757, the supporting wall portion 85 which received the pressing force from the upper duct wall portion 81 by the flat-shaped support portion 84 is separated downwardly from the lower duct wall portion 83 owing to the fracture at the planned fracture lines 86, to thereby allow further deformation of the hood. For this reason, after the further deformation of the hood is allowed to absorb the shock due to the collision with the obstacle or the like, the lower duct wall portion 83 is damaged owing to the fracture at the planned fracture lines 86, and a hole is formed in the lower duct wall portion 83. If the hole is thus formed in the lower duct wall portion 83, the reuse of this intake duct for a vehicle becomes impossible.

On the other hand, with the related intake duct for a vehicle disclosed in JP-A-2004-183514, the supporting wall portion 85 which received the pressing force from the upper duct wall portion 81 by the flat-shaped support portion 84 is deformed into the collapsed state, to thereby allow further deformation of the hood. This supporting wall portion 85 is deformed into the collapsed state as the bent portions of the both side wall portions are greatly bent in the mutually approaching directions. Therefore, once the supporting wall portion 85 is deformed into the collapsed state, it is difficult for the supporting wall portion 85 to return to its original state (or a shape close to it; hereafter the same). Even if there ceases the pressing force acting on the supporting wall portion 85 from the upper duct wall portion 81, the supporting wall portion 85 is conceivably difficult to be restored to its original shape. For this reason, the reuse of this intake duct for a vehicle after the deformation becomes practically impossible.

### SUMMARY OF THE INVENTION

The invention has been devised in view of the above-described circumstances, and its object is to provide an intake duct for a vehicle in which a measure has been taken to improve rigidity by means of a supporting portion interposed between the upper duct wall portion and the lower duct wall portion, and which can be easily reused even after the further deformation of the hood is allowed by the deformation of the upper duct wall portion.

An intake duct for a vehicle in accordance with the invention for overcoming the above-described problems is characterized by being an intake duct comprising an upper duct wall portion disposed in close proximity to a reverse side of a hood of a vehicle, and a lower duct wall portion which is disposed to oppositely face the upper duct wall portion with a required space provided therebetween so as, together with the upper duct wall portion, to form an intake port which is open toward a front side of the vehicle, and an intake passage for supplying outside air sucked from the intake port to an engine side, wherein one of the upper duct wall portion and the lower duct wall portion comprises a column portion being interposed between the upper duct wall portion and the lower duct wall portion and includes engaging means at a distal end portion thereof, and wherein a mating member, which is another one of the upper duct wall portion and the lower duct wall portion, includes mating engaging means detachable with the engaging means and an escape opening for allowing the column portion to enter therein. Further, when an external load of a predetermined value or more is applied to the upper duct wall portion, a state of engagement between the engaging means and the mating engaging means is canceled, and as the column portion enters the escape opening, the upper duct wall portion is allowed to be deformed toward a lower duct wall portion side.

In this intake duct for a vehicle, at normal times when an external load of a predetermined value or more is not applied to the upper duct wall portion, the state of engagement is maintained between the engaging means provided at the distal end portion of the column portion and the mating engaging means provided in the mating member located at the distal end side of this column portion. For this reason, since the rigidity of the intake duct is improved as the upper duct wall portion and the lower duct wall portion are connected and supported by the column portion, it is possible to effectively suppress the deformation of the intake duct due to the intake negative pressure and the like and the generation of abnormal noise consequent upon the deformation and the like.

Meanwhile, when the hood is deformed downwardly by a collision with an obstacle or the like, and the upper duct wall portion is pressed from above with an impact force to consequently apply an external load of a predetermined value or more to the upper duct wall portion, the state of engagement between the engaging means of the column portion and the mating engaging means of the mating member is canceled. When the state of engagement between the engaging means and the mating engaging means is thus canceled, in the intake duct for a vehicle of the invention, the upper duct wall portion is allowed to be deformed toward the lower duct wall portion side as the column portion enters the escape opening provided in the mating member. For this reason, if the state of engagement is canceled, the column portion enters escape opening due to the external load, with the result that the upper duct wall portion is deformed toward the lower duct wall portion side. Consequently, further deformation of the hood is allowed, accompanying such buckling deformation of the upper duct wall portion.

In the intake duct of the invention, even after the upper duct wall portion is deformed in consequence of the disengagement between the engaging means and the mating engaging means, as described above, the column portion, the lower duct wall portion, and the like are not fractured or damaged. For this reason, if only the deformed upper duct wall portion can be restored to its original shape or a shape close to it, by setting the engaging means and the mating engaging means to their original state of engagement, it subsequently becomes possible to easily restore the intake duct to the original state persisting before the deformation or a state close to it.

In a preferred form of the intake duct for a vehicle in accordance with the invention, if the external load of the predetermined value or more is applied to the upper duct wall portion, and the state of engagement between the engaging means and the mating engaging means is thereby canceled, the column portion is arranged to be capable of being freely inserted through the escape opening by a predetermined distance.

Here, the phrase “the column portion is arranged to be capable of being freely inserted through the escape opening by a predetermined distance” means that when the column portion, which is displaced accompanied by the deformation of the upper duct wall portion, is inserted through the escape opening by a predetermined distance, there is no such resistance, interference, restriction, or the like that hampers the insertion. For this reason, in this intake duct for a vehicle, if an external load of a predetermined value or more is applied to the upper duct wall portion, and the state of engagement between the engaging means and the mating engaging means is thereby canceled, concurrently with it the column portion speedily enters the escape opening owing to the external load and is inserted therethrough by the predetermined distance. In consequence, the upper duct wall portion is deformed by a lower load toward the lower duct wall portion side by a predetermined amount.

In another preferred form of the intake duct for a vehicle in accordance with the invention, the column portion comprises a grommet being fixed to a distal end portion thereof and including an annular engaging groove serving as the engaging means in an outer peripheral surface of the grommet. Further, the upper duct wall portion includes the column portion, and the lower duct wall portion serving as the mating member includes the escape opening, and the mating engaging means capable of engaging the engaging groove is formed by an opening peripheral edge portion defining the escape opening.

In this intake duct for a vehicle, the state of engagement at normal times is maintained as the opening peripheral edge portion of the escape opening provided in the lower duct wall portion serving as the mating member is engaged in a fitting manner with the annular engaging groove of the grommet fixed to the distal end portion or its vicinity of the column portion provided on the upper duct wall portion. On the other hand, at the time of a collision when a load of a predetermined value or more is applied to the upper duct wall portion, the state of engagement is canceled as the opening peripheral edge portion of the escape opening is disengaged from the annular engaging groove, accompanied by the elastic deformation of the grommet. Then, the column portion enters the escape opening together with the grommet owing to the external load, and the upper duct wall portion is consequently deformed toward the lower duct wall portion side. Since the state of engagement is thus canceled at the time of the collision while the grommet formed of rubber or the like is being elastically deformed, it is possible to more reliably suppress the breakage and the like of the column portion, the lower duct wall portion, and the like during the cancellation of the state of engagement. Accordingly, it becomes easier to reuse this intake duct for a vehicle.

In still another preferred form of the intake duct for a vehicle in accordance with the invention, the column portion comprises an engaging projecting portion serving as the engaging means which projects from an outer peripheral surface of a distal end portion or its vicinity of the column portion to an outside. Further, the upper duct wall portion includes the column portion, and the lower duct wall portion serving as the mating member includes a fixing through portion, and is provided with a tubular grommet which is fixed in the fixing through portion, and includes an escaping through portion constituting the escape opening, the tubular grommet having in its inner peripheral surface an engaging recessed portion serving as the mating engaging means capable of engaging the engaging projecting portion.

In this intake duct for a vehicle, the state of engagement at normal times is maintained as the engaging projecting portion provided at the distal end portion or its vicinity of the column portion provided on the upper duct wall portion and the engaging recessed portion of the tubular grommet fixed in the lower duct wall portion serving as the mating member are engaged with each other through the projection and the recess. On the other hand, at the time of a collision when a load of a predetermined value or more is applied to the upper duct wall portion, the state of engagement is canceled as the engaging projecting portion and the engaging recessed portion are disengaged from each other, accompanied by the elastic deformation of the tubular grommet. Then, the column portion enters the escaping through portion (escape opening) of the tubular grommet owing to the external load, and the upper duct wall portion is consequently deformed toward the lower duct wall portion side. Since the state of engagement is thus canceled at the time of the collision while the tubular grommet formed of rubber or the like is being elastically deformed, it is possible to more reliably suppress the breakage and the like of the column portion, the lower duct wall portion, and the like during the cancellation of the state of engagement. Accordingly, it becomes easier to reuse this intake duct for a vehicle.

In a further preferred form of the intake duct for a vehicle in accordance with the invention, the mating member includes an elastically deformable tubular portion having an escaping through portion constituting the escape opening, and the tubular portion includes an engaging recessed portion serving as the mating engaging means capable of engaging the engaging projecting portion in an inner peripheral surface of the tubular portion.

In this intake duct for a vehicle, the state of engagement at normal times is maintained as the engaging projecting portion provided at the distal end portion or its vicinity of the column portion and the engaging recessed portion of the tubular portion provided on the mating member are engaged with each other through the projection and the recess. On the other hand, at the time of a collision when a load of a predetermined value or more is applied to the upper duct wall portion, the state of engagement is canceled as the engaging projecting portion and the engaging recessed portion are disengaged from each other, accompanied by the elastic deformation of the tubular portion. Then, the column portion enters the escaping through portion (escape opening) of the tubular portion owing to the external load, and the upper duct wall portion is consequently deformed toward the lower duct wall portion side. Since the state of engagement is thus canceled at the time of the collision while the tubular portion is being elastically deformed, it is possible to more reliably suppress the breakage and the like of the column portion, the lower duct wall portion, and the like during the cancellation of the state of engagement. Accordingly, it becomes easier to reuse this intake duct for a vehicle.

### BRIEF DESCRIPTION OF THE DRAWINGS

FIG. 1 is a partial perspective view illustrating a major portion of an intake duct for a vehicle in accordance with a first embodiment of the invention;

FIG. 2 is a partial cross-sectional view illustrating the major portion of the intake duct for a vehicle in accordance with the first embodiment of the invention, and illustrates a state in which an external load is not applied;

FIG. 3 is a partial cross-sectional view illustrating the major portion of the intake duct for a vehicle in accordance with the first embodiment of the invention, and illustrates a state in which an external load has been applied;

FIG. 4 is a partial cross-sectional view illustrating the major portion of the intake duct for a vehicle in accordance with a second embodiment of the invention, and illustrates a state in which an external load is not applied;

FIG. 5 is a partial cross-sectional view illustrating the major portion of the intake duct for a vehicle in accordance with a third embodiment of the invention, and illustrates a state in which an external load is not applied;

FIG. 6 is a partial cross-sectional view illustrating the major portion of the intake duct for a vehicle in accordance with a fourth embodiment of the invention, and illustrates a state in which an external load is not applied;

FIG. 7 is a partial cross-sectional view of an intake passage, illustrating an intake duct for a vehicle in accordance with a related example; and

FIG. 8 is a partial cross-sectional view of the intake passage, illustrating an intake duct for a vehicle in accordance with another related example.

### DETAILED DESCRIPTION OF THE PREFERRED EMBODIMENTS

Hereafter, referring to the drawings, a description will be given of specific embodiments of the intake duct for a vehicle in accordance with the invention.

### First Embodiment

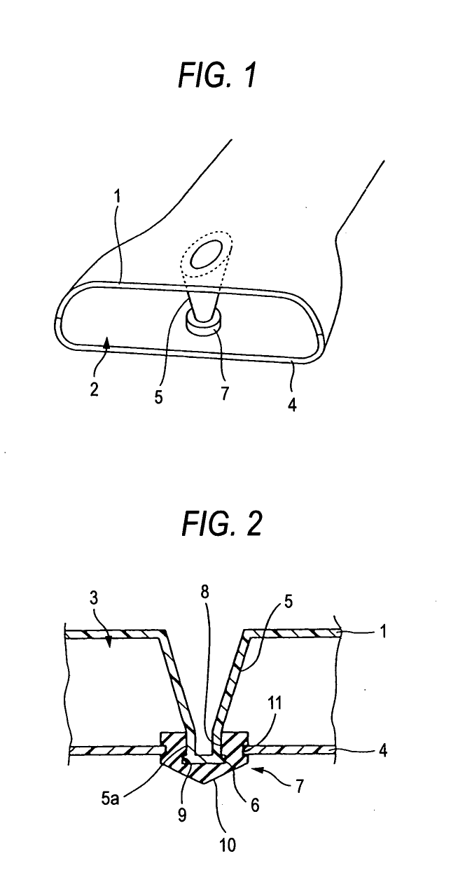

As shown in FIGS. 1 to 3, the intake duct for a vehicle in accordance with this embodiment includes an upper duct wall portion 1 and a lower duct wall portion 4 which is disposed in face-to-face relation to the upper duct wall portion 1 with a required space provided therebetween and which forms, together with the upper duct wall portion 1, a transversely elongated intake port 2 and an intake passage 3 for supplying the outside air sucked from the intake port 2 to the engine side. Opposing end portions of the upper duct wall portion 1 and the lower duct wall portion 4 are integrally joined by tightening unillustrated bolts, thereby forming the intake duct into a hollow body. It should be noted that an end portion of this intake duct opposite to the intake port 2 is formed as an unillustrated connection port which can be connected to an unillustrated air cleaner.

This intake duct for a vehicle is used by being disposed in a space between the hood and a radiator upper support of an unillustrated vehicle with the intake port 2 facing the front side of the vehicle. It should be noted that this intake duct is fixed by being bolted in a state in which an open distal end portion on the intake port side of the lower duct wall portion 4 is installed on the radiator upper support. In the form of this use, below a column portion 5, which will be described later, there are no objects which restrain the downward displacement of the column portion 5.

Each of the upper duct wall portion 1 and the lower duct wall portion 4 is molded into a flat tray shape by injecting molding from a synthetic resin material such as polyethylene (PE), polypropylene (PP), or the like. The thickness of the upper duct wall portion 1 and the lower duct wall portion 4 can be set to 0.5 to 3.5 mm.

In the upper duct wall portion 1, the column portion 5 interposed between the upper duct wall portion 1 and the lower duct wall portion 4 is provided in the vicinity of the intake port 2 by integrally protruding from the upper duct wall portion 1 toward the lower duct wall portion 4 side. The horizontal cross-sectional shape of this column portion 5 is formed in an elliptical shape in which it is elongated in the direction in which the intake passage 3 extends, so as to suppress an increase in the air flow resistance in the intake passage 3 due to the column portion 5 (see FIG. 1).

As shown in FIG. 2, the column portion 5 has an annular projecting portion 6 provided at a distal end portion 5a in such a manner as to project in a centrifugal direction, and a grommet 7 formed of a rubber elastic material is fixed to this distal end portion 5a. The grommet 7 has at its proximal end face a fitting hole 8 into which the distal end portion 5a of the column portion 5 is inserted and fitted. An annular groove 9, which restricts the grommet 7 from coming off the distal end portion 5a of the column portion 5 by engagement with the annular projecting portion 6, is formed in a side surface of a bottom portion of the fitting hole 8 of this grommet 7. Accordingly, as the distal end portion 5a of the column portion 5 is inserted and fitted in the fitting hole 8 of the grommet 7, and the annular projecting portion 6 of the column portion 5 is engaged in the annular groove 9 of the fitting hole 8, the grommet 7 is fixed to the distal end portion 5a of the column portion 5. In addition, the distal end of the grommet 7 is formed as a substantially conically shaped portion 10 having a pointed end, so as to facilitate the insertion of the grommet 7 into a through hole 12 serving as an escape opening which will be described later. Further, an annular engaging groove 11 serving as an engaging means is formed in an outer peripheral side surface of the grommet 7.

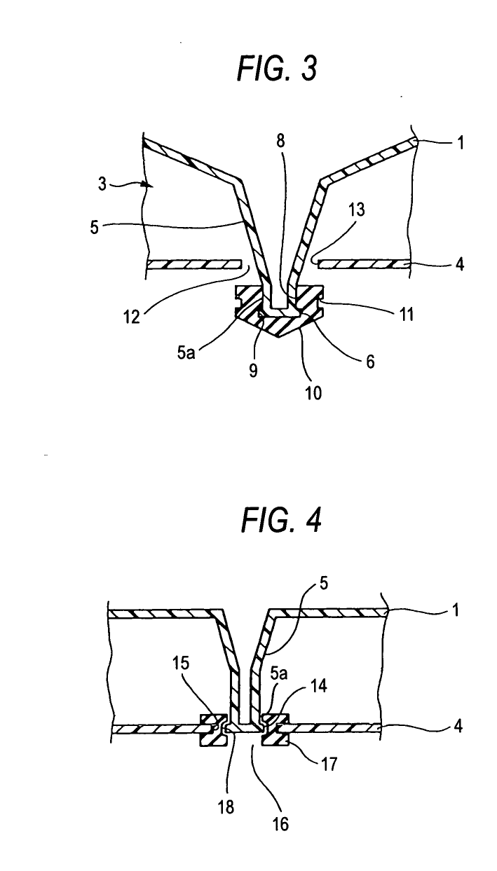

Meanwhile, a mating engaging means, which has the through hole 12 serving as the escape opening and is detachable with the annular engaging groove 11 by an opening peripheral edge portion 13 defining this through hole 12, is formed in the lower duct wall portion 4 at a position corresponding to the column portion 5 (see FIG. 3).

When the state of engagement between the annular engaging groove 11 and the opening peripheral edge portion 13 is canceled, the column portion 5 is allowed to enter the through hole 12 serving as this escape opening.

Here, the annular engaging groove 11 serving as the engaging means and the opening peripheral edge portion 13 serving as the mating engaging means are arranged such that unless an external load of a predetermined value or more is applied to the upper duct wall portion 1, the state of engagement is maintained so as to be capable of connecting and supporting the upper duct wall portion 1 and the lower duct wall portion 4 by the column portion 5 interposed therebetween, whereas when an external load of a predetermined value or more is applied to the upper duct wall portion 1, the state of engagement is canceled so as to be capable of allowing the upper duct wall portion 1 to be deformed toward the lower duct wall portion 4 side as the column portion 5 enters the through hole 12 serving as the escape opening. Specifically, the elastic deformation of the grommet 7 is entailed when the state of engagement between the annular engaging groove 11 and the opening peripheral edge portion 13 is canceled, so that the fitting length of the opening peripheral edge portion 13 with respect to the annular engaging groove 11, the modulus of elasticity of the rubber material constituting the grommet 7, and the like are adjusted to satisfy the aforementioned condition.

Accordingly, with this intake duct for a vehicle, at normal times when an external load of a predetermined value or more is not applied to the upper duct wall portion 1, the state of engagement is maintained between the annular engaging groove 11 serving as the engaging means of the grommet 7 held at the distal end portion 5a of the column portion 5 and the opening peripheral edge portion 13 serving as the mating engaging means provided in the lower duct wall portion 4 as its mating member. For this reason, since the rigidity of the intake duct is improved as the upper duct wall portion 1 and the lower duct wall portion 4 are connected and supported by the column portion 5 and the grommet 7 held by the column portion 5, it is possible to effectively suppress the deformation of the intake duct due to the intake negative pressure and the like and the generation of abnormal noise consequent upon the deformation and the like.

Meanwhile, when the hood is deformed downwardly by a collision with an obstacle or the like, and the upper duct wall portion 1 is pressed from above with an impact force to consequently apply an external load of a predetermined value or more to the upper duct wall portion 1, the state of engagement is canceled as the opening peripheral edge portion 13 is disengaged from the annular engaging groove 11 of the grommet 7 held by the column portion 5, accompanied by the elastic deformation of the grommet 7. When the state of engagement is thus canceled, in the intake duct for a vehicle of this embodiment, the upper duct wall portion 1 is allowed to be deformed toward the lower duct wall portion 4 side as the column portion 5 enters the through hole 12 serving as the escape opening provided in the lower duct wall portion 4. For this reason, if the state of engagement is canceled, the column portion 5 enters the through hole 12 due to the external load and passes therethrough together with the grommet 7, with the result that the upper duct wall portion 1 is deformed toward the lower duct wall portion 4 side. Consequently, the further deformation of the hood is allowed, accompanying such buckling deformation of the upper duct wall portion 1.

At this time, in this embodiment, the arrangement provided is such that the column portion 5 is capable of being freely inserted through the through hole 12 serving as the escape opening by a predetermined distance. Namely, the arrangement provided is such that when the column portion 5 is inserted through the through hole 12 by a predetermined distance by accompanying the deformation of the upper duct wall portion 1, there is no such resistance, interference, restriction, or the like that hampers the insertion. It should be noted that, as for the aforementioned predetermined distance, there is no particular problem insofar as the amount of deformation of the upper duct wall portion 1 can be ensured appropriately. In this embodiment, the predetermined distance is set to be a distance whereby the side wall at a root portion of the column portion 5 abuts against the opening peripheral edge portion 13. However, an arrangement may be provided such that the inside diameter of the through hole 12 serving as the escape opening is made greater than a maximum outside diameter of the column portion 5, such that the upper duct wall portion 1 is capable of abutting against the lower duct wall portion 4. If such an arrangement is provided, it is possible to ensure a maximum amount of deformation for the upper duct wall portion 1. For this reason, in this intake duct for a vehicle, if an external load of a predetermined value or more is applied to the upper duct wall portion 1, and the state of engagement between the annular engaging groove 11 and the opening peripheral edge portion 13 is thereby canceled, concurrently with it the column portion 5 speedily enters the through hole 12 owing to the external load and is inserted therethrough by the predetermined distance. In consequence, the upper duct wall portion 1 is deformed by a lower load toward the lower duct wall portion 4 side by a predetermined amount.

In addition, since the column portion 5 is provided in the vicinity of the intake port 2 which has low rigidity, the column portion 5 is capable of effectively resisting the intake negative pressure and the like at normal times.

It should be noted that although in this embodiment a description has been given of an example in which the upper duct wall portion 1 and the lower duct wall portion 4 are molded by injection molding, these members may be integrally molded by blow molding, and the through hole 12 and the like may be formed by post processing.

### Second Embodiment

In this embodiment shown in FIG. 4, the upper duct wall portion 1 has the column portion 5 and an engaging projecting portion 14 serving as the engaging means which projects from an outer peripheral surface of the distal end portion 5a of this column portion 5 to the outside.

In addition, the lower duct wall portion 4 serving as the mating member has a fixing through portion 15, and is provided with a tubular grommet 17 which is fixed to this fixing through portion 15, is formed of a rubber elastic material, and has an escaping through portion 16 constituting an escape opening. This tubular grommet 17 has in its inner peripheral surface an engaging recessed portion 18 serving as the mating engaging means detachable with the engaging projecting portion 14.

In this intake duct for a vehicle, the state of engagement at normal times is maintained as the engaging projecting portion 14 provided at the distal end portion 5a of the column portion 5 provided on the upper duct wall portion 1 and the engaging recessed portion 18 of the tubular grommet 17 fixed in the lower duct wall portion 4 serving as the mating member are engaged with each other through the projection and the recess. On the other hand, at the time of a collision when a load of a predetermined value or more is applied to the upper duct wall portion 1, the state of engagement is canceled as the engaging projecting portion 14 and the engaging recessed portion 18 are disengaged from each other, accompanied by the elastic deformation of the tubular grommet 17. Then, the column portion 5 enters the escaping through portion 16 of the tubular grommet 17 owing to the external load, and the upper duct wall portion 1 is consequently deformed toward the lower duct wall portion 4 side. Since the state of engagement is thus canceled at the time of the collision while the tubular grommet 17 formed of a rubber elastic material is being elastically deformed, it is possible to more reliably suppress the breakage and the like of the column portion 5, the lower duct wall portion 4, and the like during the cancellation of the state of engagement. Accordingly, it becomes easier to reuse this intake duct for a vehicle.

The other construction and operational effects are similar to those of the above-described first embodiment.

### Third Embodiment

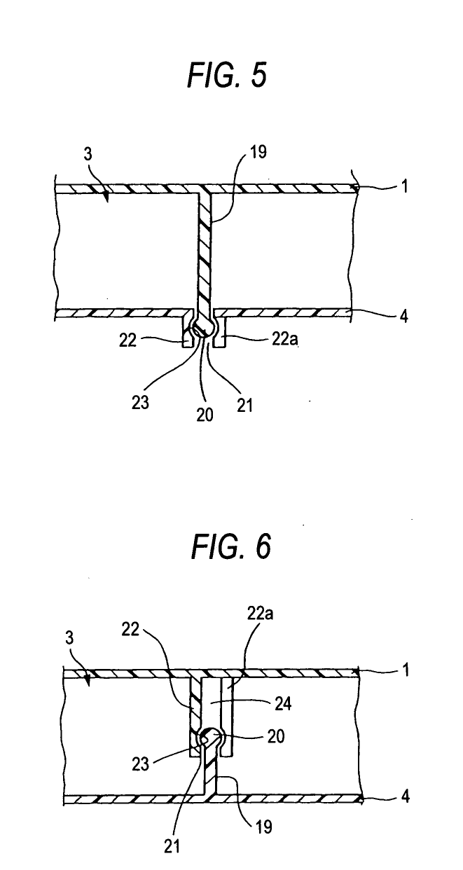

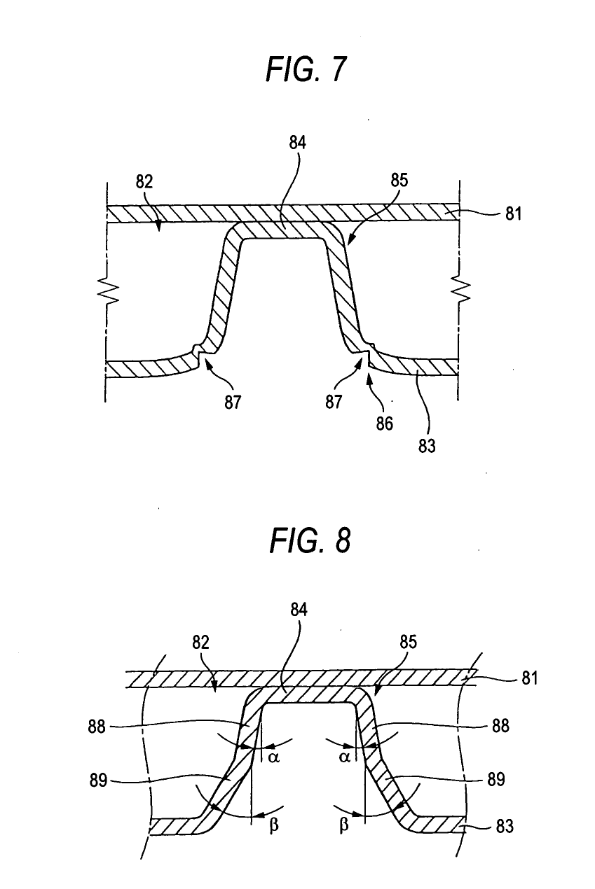

In this embodiment shown in FIG. 5, the upper duct wall portion 1 has a bar-like column portion 19 which integrally protrudes toward the lower duct wall portion 4 side, as well as a spherical engaging projecting portion 20 serving as the engaging means which projects from an outer peripheral surface of the distal end portion of this bar-like column portion 19 to the outside.

In addition, the lower duct wall portion 4 serving as the mating member is integrally provided with an elastically deformable tubular portion 22 which is disposed at a position corresponding to the bar-like column portion 19 and has an escaping through portion 21 constituting the escape opening. The tubular portion 22 has an axially extending slit 22a so as to be capable of undergoing enlargement in diameter by elastic deformation. This tubular portion 22 has in its inner peripheral surface a spherical engaging recessed portion 23 serving as the mating engaging means detachable with the spherical engaging projecting portion 20.

In this intake duct for a vehicle, the state of engagement at normal times is maintained as the spherical engaging projecting portion 20 provided at the distal end portion of the bar-like column portion 19 and the spherical engaging recessed portion 23 of the tubular portion 22 provided on the mating member are engaged with each other through the projection and the recess. On the other hand, at the time of a collision when a load of a predetermined value or more is applied to the upper duct wall portion 1, the state of engagement is canceled as the spherical engaging projecting portion 20 and the spherical engaging recessed portion 23 are disengaged from each other, accompanied by the elastic deformation of the tubular portion 22. Then, the bar-like column portion 19 enters the escaping through portion 21 of the tubular portion 22 owing to the external load, and the upper duct wall portion 1 is consequently deformed toward the lower duct wall portion 4 side. Since the state of engagement is thus canceled at the time of the collision while the tubular portion 22 is being elastically deformed, it is possible to more reliably suppress the breakage and the like of the bar-like column portion 19, the lower duct wall portion 4, and the like during the cancellation of the state of engagement. Accordingly, it becomes easier to reuse this intake duct for a vehicle.

The other construction and operational effects are similar to those of the above-described first embodiment.

### Fourth Embodiment

In an embodiment shown in FIG. 6, the lower duct wall portion 4 has a bar-like column portion 19 which integrally protrudes toward the upper duct wall portion 1 side, as well as the spherical engaging projecting portion 20 serving as the engaging means which projects from the outer peripheral surface of the distal end portion of this bar-like column portion 19 to the outside.

In addition, the upper duct wall portion 1 serving as the mating member is integrally provided with the elastically deformable tubular portion 22 which is disposed at a position corresponding to the bar-like column portion 19 and has the escaping through portion 21 constituting the escape opening as well as an escaping recessed portion 24. The tubular portion 22 has an axially extending slit 22a so as to be capable of undergoing enlargement in diameter by elastic deformation. This tubular portion 22 has in its inner peripheral surface the spherical engaging recessed portion 23 serving as the mating engaging means detachable with the spherical engaging projecting portion 20.

In this intake duct for a vehicle, the state of engagement at normal times is maintained as the spherical engaging projecting portion 20 provided at the distal end portion of the bar-like column portion 19 and the spherical engaging recessed portion 23 of the tubular portion 22 provided on the mating member are engaged with each other through the projection and the recess. On the other hand, at the time of a collision when a load of a predetermined value or more is applied to the upper duct wall portion 1, the state of engagement is canceled as the spherical engaging projecting portion 20 and the spherical engaging recessed portion 23 are disengaged from each other, accompanied by the elastic deformation of the tubular portion 22. Then, the bar-like column portion 19 enters the escaping through portion 21 of the tubular portion 22 owing to the external load, and the spherical engaging projecting portion 20 of this bar-like column portion 19 enters the escaping recessed portion 24. The upper duct wall portion 1 is consequently deformed toward the lower duct wall portion 4 side. Since the state of engagement is thus canceled at the time of the collision while the tubular portion 22 is being elastically deformed, it is possible to more reliably suppress the breakage and the like of the bar-like column portion 19, the lower duct wall portion 4, and the like during the cancellation of the state of engagement. Accordingly, it becomes easier to reuse this intake duct for a vehicle.

The other construction and operational effects are similar to those of the above-described first embodiment.

1. An intake duct comprising:
an upper duct wall portion disposed in close proximity to a reverse side of a hood of a vehicle; and
a lower duct wall portion which is disposed to oppositely face the upper duct wall portion with a required space provided therebetween so as, together with the upper duct wall portion, to form:
an intake port which is open toward a front side of the vehicle; and
an intake passage for supplying outside air sucked from the intake port to an engine side,
wherein one of the upper duct wall portion and the lower duct wall portion comprises a column portion being interposed between the upper duct wall portion and the lower duct wall portion and including engaging means at a distal end portion thereof, and
wherein a mating member, another one of the upper duct wall portion and the lower duct wall portion, includes mating engaging means detachable with the engaging means and an escape opening for allowing the column portion to enter therein.

2. The intake duct according to claim 1, wherein, when an external load of a predetermined value or more is applied to the upper duct wall portion, a state of engagement between the engaging means and the mating engaging means is canceled, and as the column portion enters the escape opening, the upper duct wall portion is allowed to be deformed toward a lower duct wall portion side.

3. The intake duct according to claim 2, wherein if the external load of the predetermined value or more is applied to the upper duct wall portion, and the state of engagement between the engaging means and the mating engaging means is thereby canceled, the column portion is arranged to be capable of being freely inserted through the escape opening by a predetermined distance.

4. The intake duct according to claim 4 claim 1, wherein the column portion comprises a grommet being fixed to a distal end portion thereof and including an annular engaging groove serving as the engaging means in an outer peripheral surface of the grommet.

5. The intake duct according to claim 4,
wherein the upper duct wall portion includes the column portion, and
wherein the lower duct wall portion serving as the mating member includes the escape opening, and the mating engaging means capable of engaging the engaging groove is formed by an opening peripheral edge portion defining the escape opening.

6. The intake duct according to claim 4, wherein the grommet comprises rubber or a thermoplastic elastomer.

7. The intake duct according to claim 4, wherein a distal end of the grommet includes a substantially conically shaped portion having a pointed end.

8. The intake duct according to claim 1, wherein the column portion comprises an engaging projecting portion serving as the engaging means which projects from an outer peripheral surface of a distal end portion or its vicinity of the column portion to an outside.

9. The intake duct according to claim 8,
wherein the upper duct wall portion includes the column portion, and
wherein the lower duct wall portion serving as the mating member includes a fixing through portion, and is provided with a tubular grommet which is fixed in the fixing through portion, and includes an escaping through portion constituting the escape opening, the tubular grommet having in its inner peripheral surface an engaging recessed portion serving as the mating engaging means capable of engaging the engaging projecting portion.

10. The intake duct according to claim 9, wherein the tubular grommet comprises rubber or a thermoplastic elastomer.

11. The intake duct according to claim 8,
wherein the mating member includes an elastically deformable tubular portion having an escaping through portion constituting the escape opening, and
wherein the tubular portion includes an engaging recessed portion serving as the mating engaging means capable of engaging the engaging projecting portion in an inner peripheral surface of the tubular portion.

12. The intake duct according to claim 1, wherein a horizontal cross-sectional shape of the column portion has an elliptical shape being elongated in a direction in which the intake passage extends.

13. The intake duct according to claim 1, wherein the column portion is provided in a vicinity of the intake port.

14. The intake duct according to claim 1, wherein an inside diameter of the escape opening is larger than a maximum outside diameter of the column portion.

15. The air intake duct according to claim 1, wherein the upper duct wall portion and the lower duct wall portion comprise polyethylene or polypropylene.

16. The air intake duct according to claim 1, wherein a thickness of the upper duct wall portion and the lower duct wall portion is in a range from to 0.5 to 3.5 mm.
